(19) United States
(12) Patent Application Publication
(10) Pub. No.: US 2014/0027352 A1
(43) Pub. Date: Jan. 30, 2014

(54) CARBON ADSORBENT AND PROCESS FOR SEPARATING HIGH-OCTANE COMPONENTS FROM LOW-OCTANE COMPONENTS IN A NAPTHA RAFFINATE STREAM USING SUCH CARBON ADSORBENT

(71) Applicants: Melissa A. Petruska, Newtown, CT (US); J. Donald Carruthers, Fairfield, CT (US); Edward A. Sturm, New Milford, CT (US); Shaun M. Wilson, Trumbull, CT (US); Joshua B. Sweeney, Katonah, NY (US)

(72) Inventors: Melissa A. Petruska, Newtown, CT (US); J. Donald Carruthers, Fairfield, CT (US); Edward A. Sturm, New Milford, CT (US); Shaun M. Wilson, Trumbull, CT (US); Joshua B. Sweeney, Katonah, NY (US)

(73) Assignee: Advanced Technology Materials, Inc., Danbury, CT (US)

(21) Appl. No.: 14/111,547

(22) PCT Filed: Apr. 17, 2012
(86) PCT No.: PCT/US12/33970

§ 371 Date: Oct. 12, 2013

Related U.S. Application Data
(60) Provisional application No. 61/476,664, filed on Apr. 18, 2011.

(51) Int. Cl. B01J 20/20; C10G 25/00

(52) U.S. Cl. CPC B01J 20/20; C10G 25/003
USPC 208/307; 502/416; 196/46

(57) ABSTRACT

A carbon adsorbent having the characteristics of: a nitrogen micropore volume at 77° K, measured as liquid capacity, that is greater than 0.30 mL/g; a neopentane capacity measured at 273° K and 1 bar, measured as liquid capacity, that is less than 7% of the nitrogen micropore volume, measured as liquid capacity; and an access pore size in a range of from 0.50 to 0.62 nm. Such adsorbent is usefully employed for contacting with hydrocarbon mixtures to adsorb low-octane, linear and mono- or di-substituted alkanes therefrom, and thereby increase octane rating, e.g., of an isomerization naphtha raffinate. Adsorption processes and apparatus are also described, in which the carbon adsorbent can be utilized for production of higher octane rating hydrocarbon mixtures.

### CROSS REFERENCE TO RELATED APPLICATION

The benefit of priority U.S. Provisional Application 61/476,664 filed on Apr. 18, 2011 is hereby is hereby claimed under the provisions of 35 USC 119. The disclosure of U.S. Provisional Application 61/476,664 is hereby incorporated herein by reference, in its entirety, for all purposes.

### FIELD

The present disclosure relates to carbon adsorbents and processes for separating high-octane components from low-octane components in hydrocarbon streams containing same, e.g., a naphtha raffinate stream discharged from an isomerization unit in a petroleum refining complex.

### DESCRIPTION OF THE RELATED ART

While significant current efforts are being focused on developing alternative, sustainable energy sources, the world will in coming decades continue to rely heavily on a gasoline economy for powering vehicles. This circumstance, in the context of increasing usage and depletion of petroleum feedstocks as energy supplies, makes it desirable to improve the efficiency of gasoline-powered engines in vehicular as well as other applications.

In processing of raw petroleum into fuel stocks, it is desirable to process fuel raw materials in a manner that maximizes the octane number, in the interest of achieving high engine efficiencies. A number of octane enhancer additives exist, which can be used to achieve increased octane rating of fuel products, but such additives in many instances can significantly adversely affect the environment. For such reason, it is preferred in fuel processing of petroleum feedstocks to subject the feedstock to isomerization, to increase the concentration of branched alkane species in the final fuel product.

Isomerization thus is widely used in petroleum refining operations to enhance octane rating of fuel fractions of refined products. To achieve further benefit of such isomerization operations, it is desirable to subject the fuel fraction after isomerization to separation processes for removal of the low octane linear and mono- or di-substituted alkane components, and to recycle such to the isomerization process. This removal of low octane linear and mono-or di-substituted alkane components also increases the multiple-branched alkane-to-linear and mono- or di-substituted alkane ratio of the refined fuel, thereby raising the octane rating of such fuel.

### SUMMARY

The present disclosure relates to carbon adsorbents and processes for separating low-octane components from high-octane components in hydrocarbon streams containing same, e.g., a naphtha raffinate stream discharged from an isomerization unit in a petroleum refining complex.

In one aspect, the disclosure relates to a carbon adsorbent having the following characteristics:

a nitrogen micropore volume at 77° K, measured as liquid capacity, that is greater than 0.30 mL/g;
a neopentane capacity measured at 273° K and 1 bar, measured as liquid capacity, that is less than 7% of the nitrogen micropore volume, measured as liquid capacity; and
an access pore size in a range of from 0.50 to 0.62 nm.

The carbon adsorbent described above may in various additional embodiments be further characterized by at least one of the following characteristics:
heat of adsorption and heat of desorption for normal paraffins and monobranched paraffins, of less than 80 kJ/mol;
attrition resistance measured by the American Society of Testing Materials (ASTM) attrition resistance determination of ASTM D4058 that is less than 1 wt % fines;
ash content below 0.3% by weight, based on weight of the adsorbent;
stability over a temperature range of from 0° C. to 375° C., in the presence of isomerization naptha raffinate;
a research octane number (RON) enhancement in adsorptive contact with isomerization naptha raffinate of at least 5 units;
a single pellet crush strength measured by ASTM D4179 that is greater than 1 pound;
hydrocarbon capacity at 175° C. and 1 bar that is greater than 0.07 g/g adsorbent;
a particulate form comprising particles in a diameter (major dimension) size range of from 0.8 to 4 mm;
a piece density that is greater than 0.8 g/cc;
a bulk density as measured by ASTM 4164 that is greater than 0.6 g/cc; and
a critical pore size in a range of from 0.35 to 0.65 nm.

In another aspect, the disclosure relates to a method of enhancing octane rating of isomerization naphtha raffinate, comprising contacting the isomerization naphtha raffinate with a carbon adsorbent of a type as variously described above, to adsorptively remove low octane components from the isomerization naphtha raffinate, and recovering from such contacting an octane rating-enhanced isomerization naphtha raffinate that is reduced in the low octane components.

In a further aspect, the disclosure relates to a naphtha raffinate stream octane enhancement system, comprising an adsorption apparatus including a carbon adsorbent as variously described above, arranged for contacting a naphtha raffinate stream with the carbon adsorbent under contacting conditions effecting adsorption by the carbon adsorbent of low octane components of the naphtha raffinate stream, and discharging from such contacting a naphtha raffinate effluent reduced in low octane components.

Other aspects, features and embodiments of the disclosure will be more fully apparent from the ensuing description and appended claims.

### BRIEF DESCRIPTION OF THE DRAWINGS

FIG. 1 is a schematic representation of a petroleum refining complex according to one embodiment of the present disclosure, including an isomerization unit and an adsorption system for production of hydrocarbon fuel of enhanced octane rating, by adsorptive removal of low octane components from a naphtha raffinate stream that is supplied by the isomerization unit.

### DETAILED DESCRIPTION

The present disclosure relates to carbon adsorbents, and processes and apparatus employing same, for removal of low octane components from hydrocarbon mixtures containing same, to produce hydrocarbon mixtures of significantly increased octane rating.

The present disclosure is based on the discovery of carbon adsorbents that have specific morphological and material characteristics that enable them to adsorptively treat hydrocarbon mixtures containing linear and branched alkane species, to produce remarkably higher octane-rated hydrocarbon mixtures. The carbon adsorbents of the disclosure are particularly useful for processing of low-olefin, low-aromatic hydrocarbon streams, such as naphtha raffinate streams from isomerization units in petroleum refineries. In such application, the carbon adsorbent preferentially adsorbs less sterically bulky low octane components so that hydrocarbon products are obtained, having octane number increases of at least five units, as measured by American Petroleum Institute Research Octane Number (RON) assay.

Carbon adsorbents of the present disclosure, having such utility for increasing octane ratings of hydrocarbon mixtures contacted therewith, include carbon adsorbents with the following characteristics: a nitrogen micropore volume at 77° K that is greater than 0.30 mL/g (as liquid) and a neopentane capacity measured at 273° K and 1 bar that is less than 5% of the nitrogen micropore volume (both measured as liquid capacities), either measurement being within the capability of a volumetric porosimeter (such as that supplied by Micromeritics of Norcross, Ga.) and an access pore size in a range of from 0.50 to 0.62 nm where a determination of access pore size is achieved through measurement of molecule penetration of probe molecules varying in kinetic diameter (e.g., i-C₄H₁₀, SF₆ and CCl₄).

Carbon adsorbents of such type can be formed by pyrolysis of polyvinylidene chloride (PVDC) precursor articles in so-called “green body” form. Such green body precursor articles are subjected to temperatures that may for example be in a range of from 600° C. to 1300° C., with such elevated temperature conditions being applied for sufficient time to form a pyrolyzate of a desired character. Following such pyrolysis treatment, the pyrolyzate may be activated by elevated temperature exposure to steam or other ambient suitable for such activation, e.g., at temperatures of from 500° C. to 1300° C.

The PVDC precursor material that is used to form such green body precursor articles may contain other resin ingredients, such as for example methyl acrylate (MA). Any suitable concentrations of other resin ingredients may be employed, as appropriate to achieve a carbon adsorbent having desired properties. For example, PVDC-MA compositions containing from 0.25% by weight to 8% by weight of methyl acrylate can be used, wherein the weight percentage of methyl acrylate is based on total weight of PVDC and MA in the green body material.

The specific time/temperature processing schedule for the green body precursor article, as employed to achieve a pyrolyzate of the desired character, may be widely varied. Specific process conditions can be readily established by multivariable empirical effort in which a specific process condition is employed and subsequently varied while keeping other process condition parameters constant, for each of the variables of interest, to identify the process conditions that aggregately produce a carbon adsorbent with the desired micropore volume, neopentane capacity and access pore size for upgrading the octane rating of hydrocarbon feedstocks.

Carbon adsorbents that are useful for achieving such enhancement of octane rating, in addition to the aforementioned micropore volume, neopentane capacity and access pore size characteristics, may have one or more of the following characteristics:
a nitrogen adsorption BET surface area greater than 800 m²/g, as measured at 77° K;
a critical pore size not exceeding 0.65 nm;
heat of adsorption and heat of desorption for C₁-C₁₀ normal paraffins and C₁-C₁₀ monobranched paraffins, of less than 80 kJ/mol;
a hydrocarbon loading capacity at 175° C. and 1 bar that is greater than 0.07 g/g adsorbent for a hydrocarbon composition containing a mixture of paraffinic hydrocarbons with low concentrations of naphthenes and aromatics and essentially no olefin content, all within a range of hydrocarbons of C₃-C₁₀;
research octane number (RON) enhancement of at least 5 units of an isomerization naphtha raffinate composition at operating conditions of 175° C. and LHSV of 2.3 hr⁻¹, as measured by a procedure according to any one or more of: ASTM D2885-10a (Online Direct Comparison Delta Octane Number); ASTM D2699 (Measurement of Research Octane Number); ASTM D2700 (Measurement of Motor Octane Number); and GC-FID PIONA analysis;
an ash content below 0.3% by weight, based on weight of the adsorbent;
an attrition resistance measured by ASTM D4058 of less than 1 wt % fines;
material stability in a temperature range of from 0° C. to 375° C., in presence of an isomerization naptha raffinate, such that regeneration of the carbon adsorbent achieves at least 80% of its original hydrocarbon adsorption capacity;
a particulate form comprising particles in a size (diameter or major dimension) range of from 1 to 4 mm, with a piece density that is greater than 0.8 g/cc;
a bulk density that is greater than 0.6 g/cc as measured by ASTM 4164.
a bulk density in a range of from about 0.6 g/cc to about 1.0 g/cc;
a single pellet crush strength measured by ASTM D4179 that is greater than 1 pound;
a critical pore size in a range of from 0.35 to 0.65 nm; and
a physical form of pellets, rods, spherical particles, honeycomb structures, or tri-lobe, or quadri-lobe shaped articles.

Carbon adsorbents of the present disclosure, characterized by suitable combinations of the various parameters and features described above, can be utilized to achieve octane rating enhancement of hydrocarbons, e.g., for fuel or other applications, in a variety of processes and processing apparatuses.

In one embodiment, the present disclosure provides a method of enhancing octane rating of isomerization naphtha raffinate, in which the isomerized naphtha raffinate is contacted with the carbon adsorbent of the present disclosure, to adsorptively remove low octane components of the raffinate, and an octane rating-enhanced isomerization naphtha raffinate reduced in the low octane components is recovered from the contacting operation.

The contacting may be carried out by flow of the isomerization naphtha raffinate through a bed of the carbon adsorbent. The adsorbent bed may be fixed in character, or alternatively it may comprise a fluidized bed of carbon adsorbent particles. The contacting may involve flow of isomerized naphtha raffinate through a bed of carbon adsorbent at a flow rate that yields a predetermined residence time of the raffinate, in order to achieve substantial reduction in the content of lower-octane linear alkanes, and high-octane character of the treated raffinate. In various embodiments, carbon adsorbents of the present disclosure can be utilized to increase octane rating of typical raffinate streams by at least 5 RON units.

The carbon adsorbent utilized for such contacting can be of any suitable size, shape and form, and can for example be in the form of beads or spherical particles, rods, tri-lobic or quadri-lobic shapes. More generally, the carbon adsorbent can have any dimensional, conformational, morphological and compositional characteristics that are effective to provide acceptable hydrodynamic performance of the bed and enhancement of octane rating of hydrocarbon mixtures contacted therewith.

In applications in which the carbon adsorbent is utilized in fixed beds, the adsorbent bed may be reposed on a grate, screen, grid or other foraminous support structure permitting fluid flow therethrough, and the specific size, shape and packing of the adsorbent material are appropriately selected to provide the desired superficial velocity, residence time, pressure drop, etc. for desired operation of the adsorbent bed and performance of the carbon adsorbent in the bed.

In applications in which the carbon adsorbent is utilized in fluidized beds, the loading of fluidized solids in the fluidizing chamber is appropriately selected to provide a requisite level of contact of the hydrocarbon mixture with the adsorbent. The fluidized bed is sized to provide sufficient residence time to achieve the desired level of octane rating enhancement of the hydrocarbon stream that is flowed through the fluidized bed, while maintaining acceptable pressure drop and other desirable operational characteristics of the fluidized bed.

Fixed bed operation may involve the provision of multiple beds in an arrangement in which each of the multiple beds of carbon adsorbent is sequentially contacted with the hydrocarbon mixture of lower octane rating. Such multiple beds may be arranged for pressure swing adsorption (PSA) operation, temperature swing adsorption (TSA) operation, vacuum swing adsorption (VSA) operation, or any combination of PSA/TSA/VSA operations.

In the pressure swing process, fluid is contacted with the adsorbent at relatively higher pressure. After adsorption processing of a desired amount of hydrocarbon mixture, pressure on the adsorbent is reduced. This causes the sorbate previously removed from the fluid and adsorbed by the adsorbent, to desorb from such adsorbent. Thus, higher pressure adsorption and lower pressure desorption can be carried out in a cyclic alternating fashion, so that the adsorbent bed is either adsorbing in active onstream operation or else the adsorbent bed is being regenerated under reduced pressure conditions, to effect desorption of previously adsorbed fluid, thereby renewing the bed of adsorbent for subsequent adsorption operation.

In the temperature swing process, fluid is contacted with the adsorbent at a relatively lower temperature, and following such contacting and adsorption of low octane linear alkanes on the adsorbent, the adsorbent bed is heated to higher temperature, e.g., by actuation of embedded heating coils, heating jackets around the adsorber vessels, heating coils/bands surrounding the adsorber vessels, flow of heat exchange medium through interior heat exchange passages in the bed, flow of heated purge gas through the bed, or other imposition of elevated temperature conditions resulting in desorption of the previously adsorbed low octane material. After the heat-mediated desorption of sorbate has been completed, the bed is allowed to cool, following which renewed contacting of the regenerated adsorbent with the hydrocarbon feed mixture can be commenced.

Both pressure swing and temperature swing operations can be conducted in a single adsorbent bed or alternatively in multiple beds. When carried out in multiple beds, at least one of the multiple beds is onstream at any given time, to provide for continuity of operation. The multiple beds may be provided in respective adsorber vessels. The respective adsorber vessels may be manifolded together, with valved inlet and outlet manifolds that are arranged to permit fluid flows to be directed to a specific one or ones of the multiple beds, so that at least one of such multiple beds is onstream, optionally with other one(s) of the multiple vessels being regenerated while offstream, e.g., by appropriate closure and opening of valves in the valved manifolds, whereby previously adsorbed material can be removed from the adsorbent beds after they are taken offstream, and such removed low octane material can be recycled or sent to other disposition.

The apparatus that is utilized for contacting the carbon adsorbent with fluid containing low octane material can be widely varied. A variety of equipment arrangements can be employed with the carbon adsorbent vessels, for processing of hydrocarbon mixtures to upgrade their octane rating, by adsorptive removal of low octane linear alkanes on the carbon adsorbent.

In one embodiment, a naphtha raffinate octane enhancement system may be provided, comprising an adsorption apparatus including a carbon adsorbent of the present disclosure. The system is arranged for contacting the naphtha raffinate stream with the carbon adsorbent to adsorb the low octane components of the naphtha raffinate stream, and produce a naphtha raffinate that is reduced in low octane components.

As discussed above, the adsorption apparatus may comprise a pressure swing adsorption apparatus, a temperature swing adsorption apparatus, or a combined pressure swing/temperature swing adsorption apparatus.

The adsorption apparatus may also, or alternatively, utilize a purge arrangement in which a purge gas is flowed through the adsorbent bed after the adsorbent has become loaded with low octane fluid components, whereby the resulting concentration gradient effects desorption of the low octane fluid components, and entrainment of such components in the purge gas stream so that the adsorbent then is “cleaned” of the low octane sorbate by the purge gas flow.

In other embodiments, the adsorbent system may include multiple adsorber vessels each containing a bed of the carbon adsorbent, with the vessels being manifolded to one another, for cyclic alternating sequential operation, in a cycle including steps of contacting the hydrocarbon mixture with the carbon adsorbent to remove the low octane components of the mixture, terminating such contacting, and regenerating the carbon adsorbent, following which the cycle is repeated.

In various other embodiments, a controller may be employed, as arranged to control the flow of a naphtha raffinate stream to a predetermined one of the multiple adsorber vessels, for carrying out the contacting of the raffinate stream with the carbon adsorbent, in the operation of the vessels according to a predetermined cyclic process, in which each of the adsorber vessels goes through the successive steps of the process in an alternating or otherwise sequential manner.

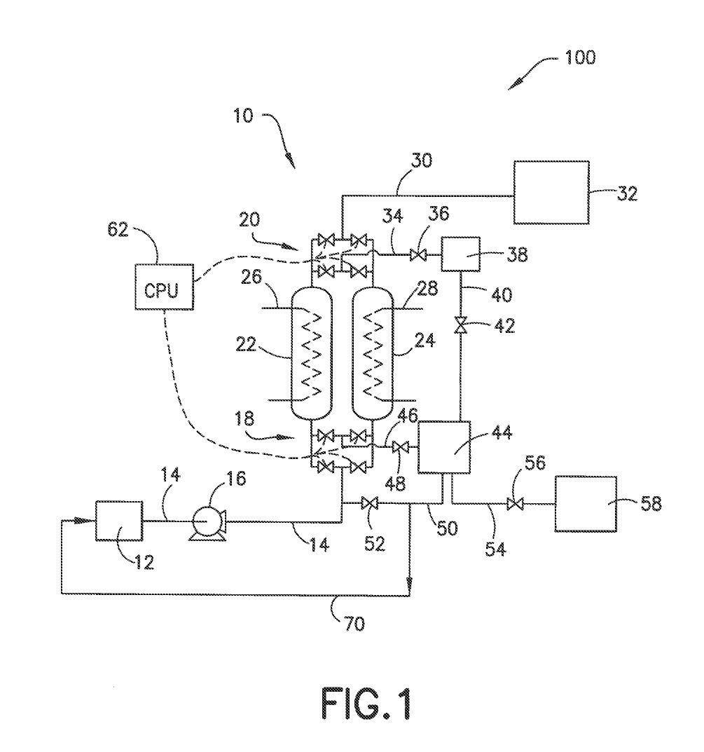

Referring now to the drawings, FIG. 1 is a schematic representation of a petroleum refining complex 100 according to one embodiment of the present disclosure, including an isomerization unit 12 and an adsorption system 10 for production of hydrocarbon fuel of enhanced octane rating by adsorptive removal of low octane components from a naphtha raffinate stream supplied from the isomerization unit.

As illustrated, the isomerization unit 12 supplies a naphtha raffinate stream to raffinate feedline 14 containing compressor 16 for delivery of the raffinate in line 14 to the adsorption system 10. The adsorption system 10 comprises adsorber vessels 22 and 24, which are manifolded to one another by an inlet manifold 18 and an outlet manifold 20. The inlet and outlet manifolds 18 and 20 are suitably valved to enable cyclic alternating operation of the adsorber vessels 22 and 24, whereby one of such vessels is onstream, while the other is either idle or is undergoing regeneration.

The inlet manifold 18 is coupled to raffinate feedline 14, so that by appropriate opening/closing of valves in such manifold, the raffinate is directed to the onstream one of the two adsorber vessels and flows upwardly through the adsorbent bed therein, to effect fluid/adsorbent contacting. As a result of such contacting, linear alkane species in the hydrocarbon mixture of the raffinate stream are adsorbed by the carbon adsorbent. The resulting linear alkane-reduced hydrocarbon mixture then flows through the outlet manifold 20 and is discharged into product line 30. From the product line 30, the linear alkane-reduced hydrocarbon mixture enters the final processing unit 32, in which the alkane-depleted (higher octane-rated) hydrocarbon mixture is blended or otherwise processed into fuel or other hydrocarbon fraction product(s).

The valving in the outlet manifold of the adsorption system 10 during this time is suitably controlled so that the off-stream adsorber vessel is isolated from the raffinate flow, and undergoes regeneration. For this purpose, a purge gas or fluid source 38 may be provided, from which a purge can be flowed through purge feedline 34 containing flow control valve 36. The purge gas then flows through the outlet manifold 20 and is passed in countercurrent flow through the off-stream one of the two adsorber vessels, so that the off-stream adsorber vessel is purged by such flow and previously adsorbed low octane components are desorbed and pass into the purge stream. The resulting mixed purge/desorbate stream then flows in purge discharge line 46, containing flow control valve 48, to the desorbate reprocessing unit 44.

The purge gas/fluid can thus be used to enhance the efficacy of the adsorber vessel regeneration process, in which the off-stream adsorber vessel at the conclusion of raffinate stream contacting is isolated by appropriate modulation of valves in the inlet and outlet manifolds, so that raffinate flow through such vessel is terminated. The off-stream vessel then can be depressurized, in a “blow-down” depressurization step, to reduce pressure and effect desorption of the previously adsorbed low octane material from the carbon adsorbent. The desorbed low octane material then can be discharged from the adsorber vessel being regenerated, in the purge discharge line 46 containing flow control valve 48, so that the desorbed low octane material passes to the desorbate reprocessing unit 44. Following this depressurization step, the purge gas can be flowed through the off-stream vessel, as previously described, to complete the removal of previously adsorbed low octane material from the adsorbent, to renew it for subsequent on-stream operation.

In the desorbate reprocessing unit 44, the purge gas/linear alkane mixture may be separated into purge gas and linear alkane portions, with the purge gas then being flowed from the reprocessing unit 44 in line 40, containing flow control valve 42, to the purge gas source 38 for replenishment of the stock of purge gas therein.

Thermal swing operation can be utilized in the FIG. 1 system, instead of or in addition to the above-described regeneration operation, by use of heating coils/bands 26, 28 wrapped exteriorly about the adsorber vessels, as schematically shown in FIG. 1.

If purge gas/fluid is not utilized for the desorption operation (i.e., if only pressure swing or temperature swing or both pressure/temperature swing operation is used to desorb the previously adsorbed linear alkanes from the carbon adsorbent), the desorbate is flowed in purge discharge line 46, containing flow control valve 48, to the reprocessing unit 44. From the reprocessing unit, the recovered desorbate may be flowed in line 50, containing flow control valve 52, to the raffinate feedline 14, for recycle to the on-stream adsorber vessel, if desired. This could be advantageous, for example, if the desorbate blending with the raffinate would produce a combined stream with better properties for processing in the adsorption system 10.

Alternatively, the recovered desorbate may be flowed in line 50 to recycle line 70 for return to the isomerization unit 12, for isomerization thereof in the operation of the isomerization unit.

As a still further alternative, the recovered desorbate may be flowed from the reprocessing unit 44 in line 54, containing flow control valve 56, to the alkane processing unit 58, or to other disposition or use.

The FIG. 1 petroleum refining complex 100 as illustrated includes a central processor unit (CPU) 62, which is shown (by dashed line representations of control signal transmission lines) as being operatively coupled to valves in the inlet and outlet manifolds of the adsorption system 10. Although the CPU 62 is shown as only being operatively linked to valves in the inlet and outlet manifolds, it will be appreciated that the CPU may additionally or alternatively be operatively linked to other valves and components in the petroleum refining complex, as part of an integrated monitoring and control system for such refining complex.

Although the foregoing description has been primarily directed to continuous processing of hydrocarbon mixtures containing linear alkanes, it will be appreciated that the carbon adsorbent of the present disclosure can be utilized in batch or semi-batch processes, to produce hydrocarbon mixtures reduced in linear alkane content, e.g., utilizing a series of adsorbent beds operated in either continuous or batch mode. Further, while the description has been primarily directed to naphtha raffinate processing, it will be recognized that other hydrocarbon mixtures will be susceptible to processing for production of high-octane product streams, in other embodiments of the disclosed process and apparatus systems.

Thus, while the disclosure has been has been set out herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the invention as hereinafter claimed is intended to be broadly construed and interpreted, as including all such variations, modifications and alternative embodiments, within its spirit and scope.

1. A carbon adsorbent comprising the following characteristics:
a nitrogen micropore volume at 77° K, measured as liquid capacity, that is greater than 0.30 mL/g;
a neopentane capacity measured at 273° K and 1 bar, measured as liquid capacity, that is less than 7% of the nitrogen micropore volume, measured as liquid capacity; and
an access pore size in a range of from 0.50 to 0.62 nm.

2. The carbon adsorbent of claim 1, comprising a nitrogen adsorption BET surface area greater than 800 m²/g, as measured at 77° K.

3. The carbon adsorbent of claim 1, comprising a critical pore size not exceeding 0.65 nm.

4. The carbon adsorbent of claim 1, characterized by heat of adsorption and heat of desorption that are less than 80 kJ/mol for C₁-C₁₀ normal paraffins and C₁-C₁₀ mono- or di-substituted paraffins.

5. The carbon adsorbent of claim 1, characterized by a hydrocarbon loading capacity at 175° C. and 1 bar that is greater than 0.07 g/g adsorbent for a hydrocarbon composition containing a mixture of paraffinic hydrocarbons with low concentrations of naphthenes and aromatics and essentially no olefin content, all within a range of hydrocarbons of C₃-C₁₀.

6. The carbon adsorbent of claim 1, characterized by a research octane number (RON) enhancement of at least 5 units of an isomerization naphtha raffinate composition at operating conditions of 175° C. and LHSV of 2.3 hr⁻¹, as measured by a procedure according to any one or more of: ASTM D2885-10a (Online Direct Comparison Delta Octane Number); ASTM D2699 (Measurement of Research Octane Number); ASTM D2700 (Measurement of Motor Octane Number); and GC-FID PIONA analysis.

7. The carbon adsorbent of claim 1, characterized by an ash content below 0.3% by weight, based on weight of the adsorbent.

8. The carbon adsorbent of claim 1, characterized by an attrition resistance, as measured in accordance with ASTM D4058, of less than 1 wt % fines.

9. The carbon adsorbent of claim 1, characterized by material stability in a temperature range of from 0° C. to 375° C., in presence of an isomerization naptha raffinate, such that regeneration of the carbon adsorbent achieves at least 80% of its original hydrocarbon adsorption capacity.

10. The carbon adsorbent of claim 1, characterized by a particulate form comprising particles in a size range of from 0.8 to 4 mm, with a piece density that is greater than 0.8 g/cc.

11. The carbon adsorbent of claim 1, characterized by a bulk density that is greater than 0.6 g/cc.

12. The carbon adsorbent of claim 1, characterized by a bulk density in a range of from about 0.6 g/cc to about 1.0 g/cc.

13. The carbon adsorbent of claim 1, characterized by a single pellet crush strength as measured in accordance with ASTM D4179 that is greater than 1 pound.

14. The carbon adsorbent of claim 1, characterized by a critical pore size in a range of from 0.35 to 0.65 nm.

15. The carbon adsorbent of claim 1, in a physical form of pellets, rods, spherical particles, honeycomb structures, or tri-, or quadri-lobe shaped articles.

16. A method of enhancing octane rating of isomerization naphtha raffinate, comprising contacting the isomerization naphtha raffinate with a carbon adsorbent according to claim 1, to adsorb/remove low octane components of the isomerization naphtha raffinate on the carbon adsorbent, and recovering from said contacting an octane rating-enhanced isomerization naphtha raffinate reduced in said low octane components.

17. The method of claim 16, wherein said contacting comprises flow of said isomerization naphtha raffinate through a bed of said carbon adsorbent, wherein said bed of said carbon adsorbent comprises a fixed carbon adsorbent bed or a fluidized carbon absorbent bed.

18.-19. (canceled)

20. The method of claim 16, wherein said contacting is carried out in a pressure swing adsorption process, a temperature swing adsorption process, a vacuum swing adsorption process, or a combined pressure swing adsorption/temperature swing adsorption process.

21.-24. (canceled)

25. An isomerization naphtha raffinate stream octane enhancement system, comprising an adsorption apparatus comprising a carbon adsorbent according to claim 1, arranged for contacting an isomerization naphtha raffinate stream with said carbon adsorbent under contacting conditions effecting adsorption by the carbon adsorbent of low octane components of the isomerization naphtha raffinate stream, and discharging from said contacting an isomerization naphtha raffinate effluent reduced in low octane components.

26. The system of claim 25, wherein: the adsorption apparatus comprises a pressure swing adsorption apparatus, a temperature swing adsorption apparatus, a vacuum swing adsorption apparatus, or a combined pressure swing adsorption/temperature swing adsorption apparatus; and wherein the adsorption apparatus comprises multiple adsorber vessels each containing said carbon adsorbent, and manifolded to one another for cyclic alternating sequential operation in a cycle including said contacting, and regeneration of said carbon adsorbent after said contacting for subsequently renewed contacting with said isomerization naphtha raffinate stream and further comprising a controller arranged to control flow of said isomerization naphtha raffinate stream to a predetermined one of said multiple adsorber vessels for said contacting, in said cyclic alternating sequential operation.

27.-31. (canceled)
